(19) United States
(12) Patent Application Publication
(10) Pub. No.: US 2026/0254617 A1
(43) Pub. Date: Aug. 27, 2026

(54) METHOD OF OPERATING A BLOCKCHAIN WALLET

(71) Applicant: QUANTUM EMOTION CORP., Montréal (CA)

(72) Inventors: Muhammad Muneem SHABIR, Montreal (CA); Kaiwen ZHANG, Montreal (CA)

(21) Appl. No.: 19/469,668

(22) PCT Filed: Mar. 28, 2024
(86) PCT No.: PCT/CA2024/050391

§ 371 Date: Sep. 26, 2025

Related U.S. Application Data
(60) Provisional application No. 63/493,036, filed on Mar. 30, 2023.

(51) Int. Cl. H04L 9/08; H04L 9/00; H04L 9/30

(52) U.S. Cl. CPC H04L 9/0825; H04L 9/0869; H04L 9/3066; H04L 9/50; H04L 2209/56

(57) ABSTRACT

The method can include receiving a key generation request from a user; providing at least one value of a cost parameter associated to the user; calculating a cost value for a first key generation scheme using a cost function for the first key generation scheme and the at least one value of a cost parameter; calculating a cost value for a second key generation scheme using a cost function for the second key generation scheme and the at least one value of a cost parameter; comparing the cost value for the first key generation scheme to the cost value for the second key generation scheme; selecting one of the first key generation scheme and the second key generation scheme based on the results of the comparison; generating a blockchain key based on the selected key generation scheme; and storing the blockchain key in a non-transitory computer memory.

### BACKGROUND

Cryptocurrency wallets 10, 110 are devices or other physical media which are associated to computer-implemented applications and used to store digital keys 12, 112. A basic functionality of most cryptocurrency wallets 10, 110 are to store private keys for cryptocurrency transactions, although keys may be used in other contexts such as signing information (e.g. for the execution of a smart contract). In other words, in a blockchain 14 context, like Bitcoin or Ethereum, the wallet 10, 110 does not hold the actual currency, but digital keys 12, 112 which allow to perform a transaction on the currency. Different approaches to wallets 10, 110 can be classified in two general families: hot or cold, sometimes alternately referred to as software or hardware. In a “hot” or “software” scheme, an example of which is presented in FIG. 1, the wallet 10 has Internet 16 connectivity, such as by being provided as a web-based application or directly in the memory of a user's computer 18, for instance, which can be convenient for the user, but open to certain types of cyberattacks. In the “cold” or “hardware” scheme, an example of which is presented in FIG. 2, the wallet 110 can be embodied as a standalone electronic device 120 which remains unconnected to the Internet between periods of use. The electronic device 120 can be in the form of a hard drive or usb key for instance, and not have inherent internet connectivity. Internet connectivity can be provided by connecting the electronic device 120 to a computer 18 which has internet connectivity for instance. A cold wallet may provide a natural protection to some types of web-based cyberattacks and may thus provide higher security from that standpoint. In the theoretical case where a user would lose access to his/her keys, he/she may no longer be able to spend cryptocurrencies he/she possesses, and one of the main motivations for the use of cryptocurrency wallets is to provide solutions to this potential problem. As opposed to self-hosted wallets, some service providers will even provide custody service whereby they manage keys on behalf of the users, who can authenticate on their platform. The service provider can restore the keys in the event of a lost password or destruction of an electronic device hosting a cold wallet, for instance.

A typical use case today involves generating a pair of keys: a public key for receiving cryptocurrency at an address, and a private key for spending cryptocurrency from the address, this scheme is sometimes referred to as asymmetric cryptography and is considered a significant improvement over an alternative option referred to as symmetric key algorithms. In asymmetric cryptography, only the holder of the private key needs to keep his/her key secret for the transaction to be secure, sharing of the public key does not inherently pose a security threat.

There are different types of technologies which exist to generate pairs of public and private keys. In a blockchain context, transactions and balances are incorporated to public ledgers and can be seen by anyone. This generates a motivation to use many different addresses, and associated keys, per user, such as using different addresses for different transactions, allowing to shield the overall account balance associated to a user from public view for instance. One type of technology is the non-deterministic (ND) wallet. This type of wallet generates each key randomly. The wallet holding these keys needs to store each and every single private key used as an address, as well as a buffer of future keys that may have already been given out as addresses but not received payments yet. This represents a significant “cost” associated to the volume of data required, and perhaps more significantly, there was no upper limit to the amount of data which may be required.

More recently, hierarchical deterministic (HD) wallets have become significantly more popular than ND wallets, and are proposed in BIP32. In the context of a HD wallet, a single key string generated randomly can be used to generate an entire tree of key pairs with a stratified structure. A modern HD wallet can be backed up by storing a single seed of 64 bytes, and the seed can be represented as a mnemonic phrase of 12 or more words to make it easier for a user to remember it by heart. In a HD wallet, the wallet seed derives a single master key, which can be used to derive child keys, each of which can derive their own children keys. Each child key in the tree can be described by its derivation path, which contains information about a key's depth and index. The tree is deterministic: a given seed or master key will always generate the exact same tree of children keys.

At the source of any key is a random number. A typical way of generating a random number is the use of pseudo-random algorithms. While satisfactory to a certain degree, pseudo-random algorithms remain deterministic and therefore are potentially predictable (crackable). True random numbers may be generated by quantum mechanical means, sometimes referred to as Quantum Random Number Generator (QRNGs), which offer a more secure alternative. In recent years, technologies have been developed allowing to generate truly random numbers from a quantum source at a relatively high throughput, such as via the use of a quantum tunneling barrier and deterministic noise removal, for instance.

### SUMMARY

While HD key generation schemes can simplify the backup process, they can have vulnerabilities to certain types of attacks, such as privilege escalation and brute-force attacks. Notwithstanding the issues with backup complexity and memory utilization, ND key generation scheme may provide better risk distribution.

Indeed, while wallets built on HD key generation scheme may save a lot of memory and be easier to restore, they are associated to some security issues, such as the possibility of all addresses being compromised if a single child key and its parent key are compromised or leaked. In security terms, this is referred to as privilege escalation attack. Furthermore, the random seed becomes the single point of failure for the entire wallet and can be considered a target for brute-force attacks by the attackers.

ND key generation scheme can have a better distribution of funds across different uncorrelated keys. However, it may have greater backup complexity and the inconvenience of linearly scaling memory utilization to store all keys.

Blockchain is highly dynamic in terms of use, such as fund transfers, trade, betting, games, services, etc. All of these require different security primitives and can affect wallet's performance in different ways. Thus, selecting the correct key generation scheme for a user can be a significant design decision and relying on single type of key generation scheme may lead to sub-optimal security and/or compromised performance.

In this specification, the terms “key generation scheme” and “key generation architecture” are used interchangeably.

This specification addresses key generation architecture selection, i.e. the selection of key generation architecture based on user behavior. Significant factors include: number of addresses, frequency of transactions, amount being transferred, and required level of security, etc.

This specification proposes a theoretical formulation of the key generation architecture selection problem which addresses the trade-offs between HD and ND key generation schemes that can co-exist to facilitate different requirements.

A new type of blockchain wallet is proposed, having a combination of more than one key generation scheme (e.g., HD and ND key generation schemes). The wallet utilizes a selection module (or “selector”) which evaluates different cost parameters and selects a key generation architecture to optimize overall cost of the wallet. Moreover, QRNG may be used for randomness, rendering any brute force attack impossible due to very high entropy.

The wallet architecture selection problem can be formulated as a decision optimization problem. A matching theory is leveraged, and deep learning can be used to approximate a solution. The following elements are proposed: a blockchain wallet that using hybrid wallet architecture, including ND and HD; a key manager for simplified backup process; a formulation of a wallet architecture problem as a decision selection problem and a matching theory based key generation architecture selector to solve the problem; a deep learning-based approximation model for predicting user's cost parameters, particularly useful in cases where users are uncertain of their cost parameter values; comprehensive experiments to assess the performance of the proposed wallet design, as well as the effectiveness of the deep learning-based key generation architecture selection.

In accordance with one aspect, there is provided a computer-implemented method of operating a blockchain wallet, the method comprising: receiving a key generation request from a user; providing at least one value of a cost parameter associated to the user; calculating a cost value for a first key generation scheme using a cost function for the first key generation scheme and the at least one value of a cost parameter; calculating a cost value for a second key generation scheme using a cost function for the second key generation scheme and the at least one value of a cost parameter; comparing the cost value for the first key generation scheme to the cost value for the second key generation scheme; selecting one of the first key generation scheme and the second key generation scheme based on the results of the comparison; generating a blockchain key based on the selected key generation scheme; and storing the blockchain key in a computer memory.

Many further features and combinations thereof concerning the present improvements will appear to those skilled in the art following a reading of the instant disclosure.

### DESCRIPTION OF THE FIGURES

In the figures,

FIG. 1 is a schematic view of an example of a “hot” blockchain wallet configuration;

FIG. 2 is a schematic view of an example of a “cold” blockchain wallet configuration;

FIG. 3 is a flow chart of an example method of operating a blockchain wallet;

FIG. 4 is a flow chart of another example method of operating a blockchain wallet;

FIG. 5 is a block diagram of an example blockchain wallet system;

FIG. 6 is a block diagram of another example of a blockchain wallet system;

FIGS. 7a to 7d are graphs representing memory utilisation in accordance with one example use case;

FIGS. 8a to 8d are graphs associated to cost parameter value estimation;

FIG. 9 is a graph representing risk assessment; and

FIG. 10 is a schematic view of a computer.

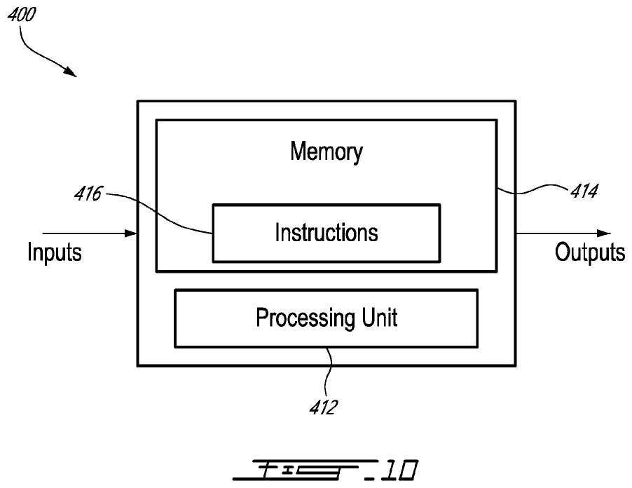

### DETAILED DESCRIPTION

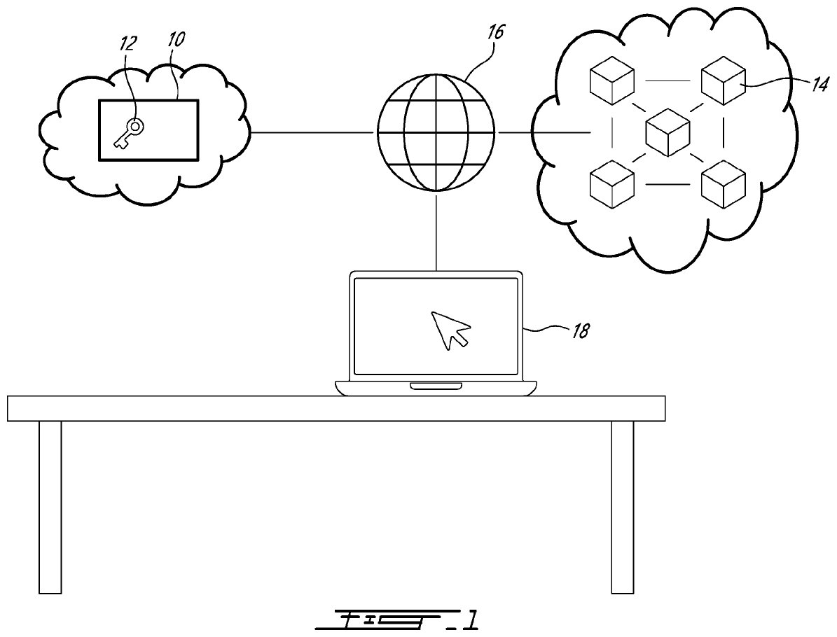

FIG. 1 shows an example of a “hot” blockchain wallet 10 embodiment. In the example presented in FIG. 1, keys 12 are stored in a persistent computer memory which is provided in the form of a cloud service (i.e., a server computer which is remote to the computer which is used by the user to access the keys). To access the keys, a user can use a computer, such as his/her personal computer 18, which communicates with the cloud service via the Internet 16. Once the key(s) 12 are retrieved, the user can perform a transaction in a blockchain service 14, such as spending cryptocurrency such as Bitcoin or Ethereum. Such operations typically involve software applications running both locally on the user's computer, and remotely, such as in a key storage service server and a blockchain server, such as authentication processes, key generation processes, interfacing processes, etc.

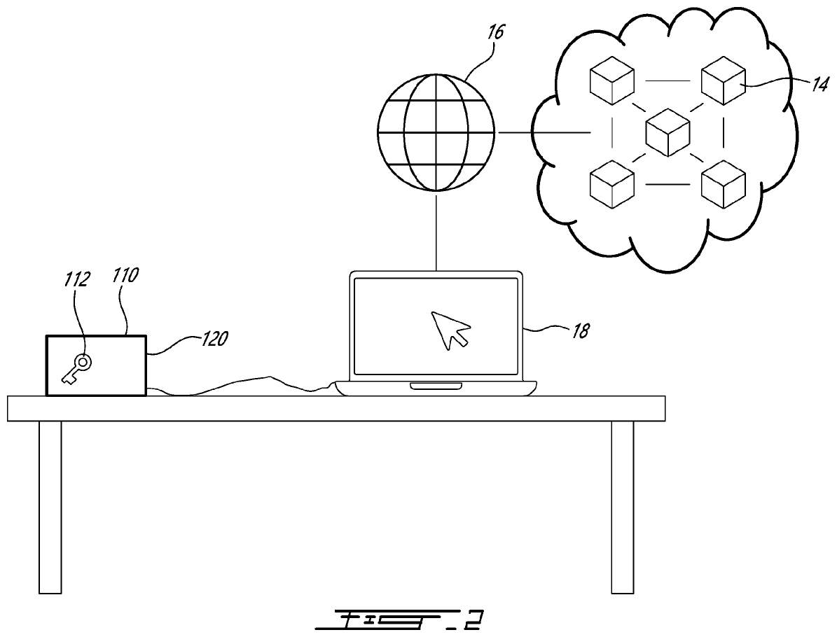

FIG. 2 shows an example of a “cold” blockchain wallet embodiment. In the example presented in FIG. 2, keys 112 are stored in an electronic device 120 which may be physically distinct from the computer 18 used by the user to perform a blockchain transaction. The electronic device 120 hosting the “cold wallet” 110 may be devoid of any communication feature other than a wired connectivity to the computer 18 used by the user to perform a blockchain transaction, and may therefore be entirely partitioned from the Internet 16 when the wired connection is physically disconnected. The electronic device 120 may have some integrated computer functionality, such as an application allowing to generate, store and retrieve keys in response to a user request, and optionally rely more or less on processes running on the computer 18 used by the user to perform a blockchain transaction (e.g. an authentication process).

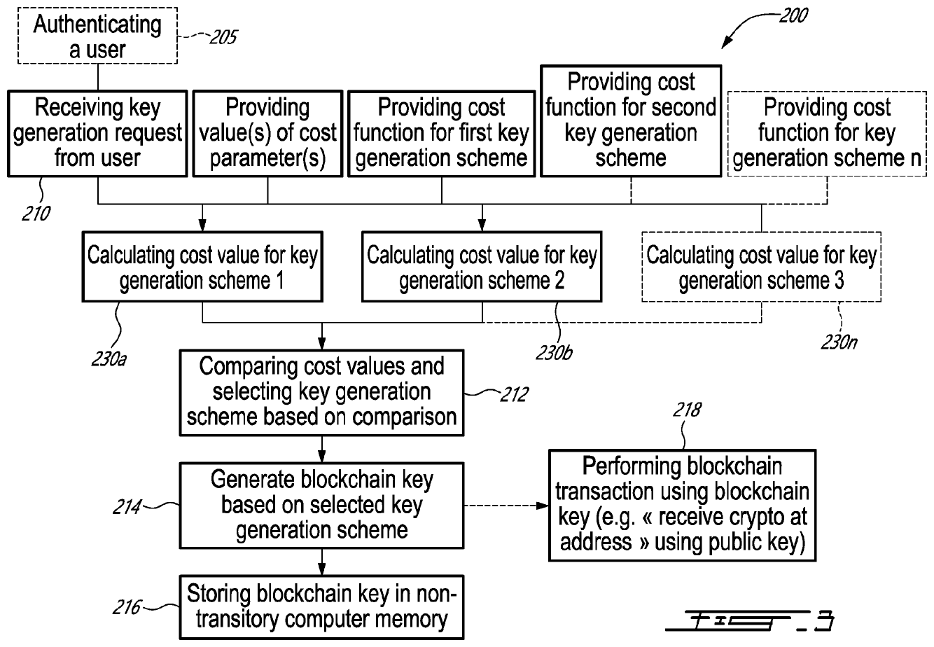

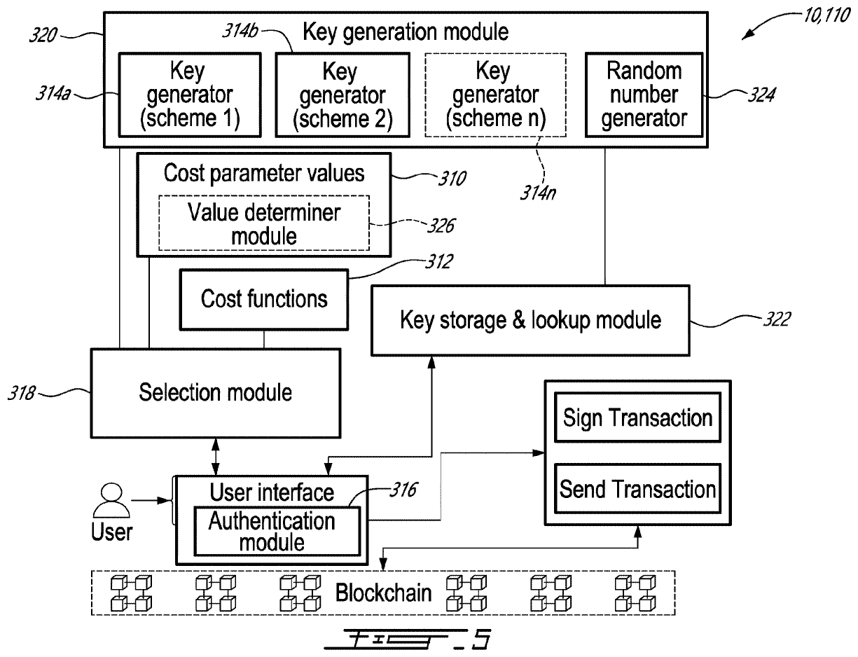

FIG. 3 is a flow chart illustrating a method 200 of operating a blockchain wallet. In this example, rather than offering a single key generation scheme, such as an HD generation scheme, the blockchain wallet offers two, or more, key generation schemes, and a selection function allowing to select one of the key generation schemes taking into consideration certain factors represented by one or more values of associated cost parameters 310, as shown in the block diagram of FIG. 5.

In the method of operation presented in FIG. 3, the cost values 310 are calculated 230a, 230b, 230n for each key generation scheme. The cost values 310 are calculated using values provided for the one or more cost parameters, and using cost functions 312 associated to each one of the key generation schemes 314a, 314b, 314n. The cost values 310 can be calculated following a user request 210 to generate one or more keys. Receiving the user request 210 may involve authenticating the user 205, for instance. Once the cost values 310 have been calculated for all key generation schemes, the costs values 310 associated to the different key generation schemes 314a, 314b, 314n, are compared 212 to one another, and one of the key generation schemes can be selected based on the comparison. At that stage, one or more blockchain key can be generated 214 using the selected key generation scheme. The blockchain key(s) 12, 112 are typically stored 216 in a non-transitory computer memory of the blockchain wallet 10, 110. The blockchain keys 12, 112 may also be used to perform 218 a blockchain transaction at that point in time, or used to allow a blockchain transaction at a later point in time. For instance, if a private key and a public key are generated, the public key may be shared in order to allow receiving cryptocurrency at an address, and the private key may be stored for the purpose of allowing the user to eventually spend the cryptocurrency which will have been received at the address.

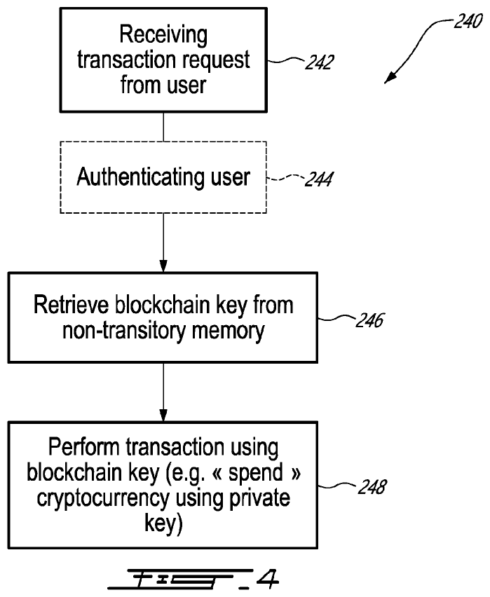

A process 240 of spending cryptocurrency can be as follows. Referring to FIG. 4, when the user wishes to spend the crypto currency, the user may generate 242 a transaction request, which may involve authenticating the user 244. Using the blockchain wallet 10, 110, the user may then retrieve the private key from the persistent (e.g. non-transitory) memory, and perform 248 the transaction using the private key.

FIG. 5 presents a block diagram of an example of a blockchain wallet system 10, 110. As can be seen in FIG. 5, a blockchain wallet system 10, 1100 may have a plurality of software applications or processes running on computer hardware in a local or distributed manner. These software applications or processes will be referred to as applications, modules, processes, or functions herein. The expression module will be used for short in the following paragraph. The modules can include user interface modules, which can include an authentication module 316, a selection module 318, a key generation module 320, and a key storage & lookup module 322. The key generation module 320 may have different key generator functionalities, such as the ability to generate a key using different available types of schemes. The key generation module 320 can have a random number generator 324, preferably a quantum random number generator (QRNG) allowing to generate a “true” random number, or alternately a pseudo random number generator (PRNG). The selection module 318 can be aware of the different key generator schemes 314a, 314b, 314n, and have access to cost functions 312 associated to the different key generator schemes 314a, 314b, 314n. The selection module 318 can use, as an input to the cost functions 312, cost parameter values 310. The cost parameter values 310 can be provided directly from a user, e.g. via the user interface, or be determined in an automated manner (e.g. via a value determiner module 326). Indeed, in some cases, it may be preferred to determine the cost parameter values automatically, such as via an algorithmic software process or via artificial intelligence, based on data stored in a non-transitory memory about a history of past usage of key generations or transactions by the user. The key storage and lookup module 322 can facilitate the storing of the keys or the retrieval of the keys from the non-transitory memory. Accordingly, via the user interface, a user may generate new keys, or retrieve keys, and perform transactions in the blockchain.

Popular cryptocurrencies, including Bitcoin, Ethereum, and Litecoin, employ elliptic-curve cryptography (ECC) with secp256k1 domain parameters and 256-bit key pairs to sign and verify transactions. To transfer funds, a user signs a transaction with their private key and transfers it to the recipient's public key, which must be known to the sender. Users publish their public key in a specific format called an address, but this raises privacy concerns as anyone with internet access can discover the user's address and track their transactions. Therefore, users frequently change their addresses. It is recommended that for each transaction, a new address should be used.

In order to maintain anonymity, it is recommended that a user employs a new address for each transaction, whether to receive funds or to return any remaining asset value to their account.

One suggested approach to achieve this is through the use of hierarchical deterministic (HD) wallets, as described in BIP32. This involves a tree of private keys, with each node being derived from its parent using child key derivation (CKD) algorithm. The root of the tree is referred to as the ‘master private key’, which is derived from a random value known as the ‘master seed’. However, the entire security of the wallet depends on the security of the master private key, which could be vulnerable to attacks such as brute-force and privilege escalation attacks.

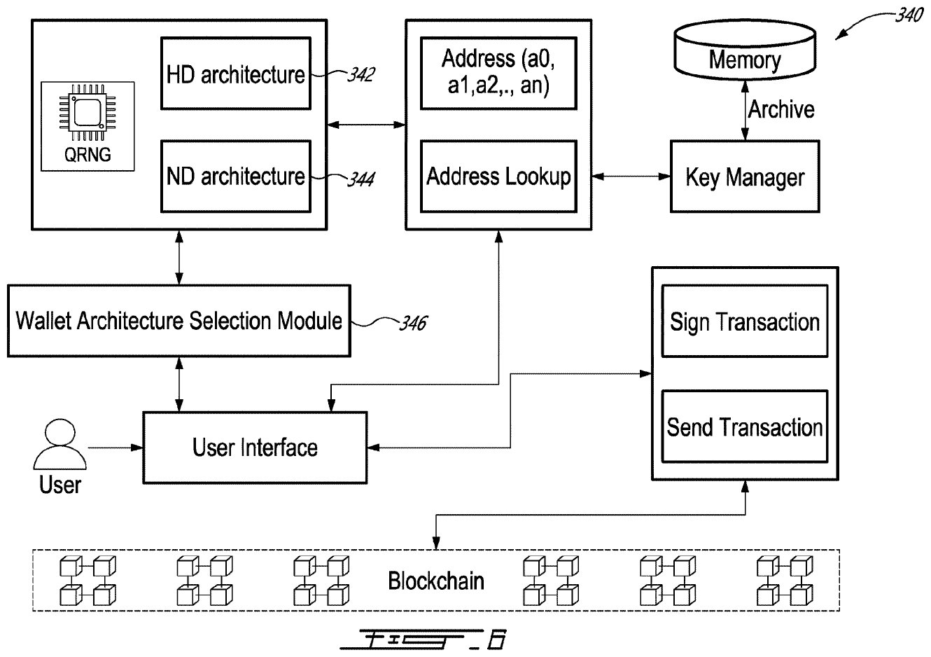

In one embodiment, presented at FIG. 6 a hybrid wallet 340 that uses both hierarchical deterministic and non-deterministic key generation architectures 342, 344 is proposed to alleviate issues related to HD wallets in some embodiments. A selection module 346 is connected with the users as well as different key generation architectures. A representation of the problem of optimal key generation selection is provided. The problem can be resolved via the selection module.

### Problem Statement

System Model: We consider a blockchain wallet, with U user sessions. We also consider J key generation architectures for the private-key generation, that includes non-deterministic and hierarchical deterministic architectures 342, 344, as shown in the example embodiment presented in FIG. 6. The example blockchain wallet system presented in FIG. 6 will be referred to as Qwallet hereinbelow.

Blockchain users can have different wallet architecture requirements, relying on a single architecture can put limits on certain parameters, which can be alleviated by using a different key generation architecture.

Cost Minimization Problem Formulation: an adaptive selector determines which key generation architecture to use in order to minimize memory costs, latency costs, as well as security parameter costs. There are four components to the total cost Ct, which must be minimized jointly: memory cost, latency cost, unlinkability cost, and unforgeability cost.

Decision Variable: A binary decision variable wⱼ is formulated that corresponds to the selection of key generation architecture for user's sessions u∈U.

The decision variable wⱼ, ∀j∈J reflects that whether a key generation architecture j has been selected (wⱼ=1) for an blockchain wallet user's session or not (wⱼ=0). We require that for every decision model solution, j key generation architecture should be selected for a blockchain wallet user's session. Moreover, the same key generation architecture j can be selected for more than one user's session. Let w̅=(wⱼ)_{∀j∈J}, the set of all decision variables is given by equation 1.

$$\\ \begin{matrix}𝒲 = \overline{w} \vert {\sum }_{j ∈ J} {w}_{j} = 1 and {w}_{j} ∈ \{ 0 , 1 \} , ∀ j ∈ J & ( 1 )\end{matrix}$$

Overall Cost: The overall cost that needs to be minimized includes the following elements:
(1) The Memory Utilization Cost refers to the price set by hardware manufacturers for memory hardware that needs to be embedded and extended on a blockchain wallet device. The selector should choose the key generation architecture that incur minimum memory cost. Let H_{c}∈ [symbol] denotes the blockchain user's per MB hardware memory cost for j^{th} key generation architecture. Furthermore, let j={1,2} be the total number of key generation architectures, the selector should choose the key generation architecture for a session with minimum memory price as given by equation 2

$$\\ \begin{matrix}{M}_{price} ( u , {w}_{select} ) = {min}_{∀ j ∈ J} {H}_{c} ( u , {w}_{j} ) & ( 2 )\end{matrix}$$

Where M_{price} is the total price of selected key generation architecture, while w_{select} is the selected architecture. Thus, the total monetary cost to backup the keys through a selected architecture is given by equation 3

$$\\ \begin{matrix}{M}_{mom} ( \overline{w} ) = {w}_{j} {ℳ}_{util} {H}_{c} & ( 3 )\end{matrix}$$

Where [symbol] ᵤₜᵢₗ is the total memory required to backup the generated keys, where,

$$\\ \begin{matrix}{ℳ}_{util} = {N}_{addr} {m}_{addr} & ( 4 )\end{matrix}$$

$$\\ \begin{matrix}{N}_{addr} = {ϕ}_{1} & ( 5 )\end{matrix}$$

$$\\ \begin{matrix}{ℳ}_{util} = {ϕ}_{1} {m}_{addr} & ( 6 )\end{matrix}$$

Nₐ are the number of addresses user utilizes per session, and m_{addr} is the MB required to backup a single address.

$${M}_{m o n} ( \overline{w} ) = {ϕ}_{1} ( {w}_{j} {m}_{addr} {H}_{c} ) \qquad ( 7 )$$

(2) The latency cost incurs when users intend to generate a key and send a transaction to the network, the latency of key generation can incur a financial cost to them, i.e., the user is unable to trade for the time key is being generated and transaction is sent. e.g., some fast-paced scenarios, i.e., automatic trading may require actions during the key generation interval.

$$L ( u , {w}_{s e l e c t} ) = {min}_{∀ j ∈ J} {T}_{d} ( u , {w}_{j} ) \qquad ( 8 )$$

In equation 8, Td is the delay between the new key required and the key generated, additionally, T_{d} has several components involved as shown in equation 9

$${T}_{dly} = {T}_{s etup} + {T}_{generate} + {T}_{sign} + {T}_{send} \qquad ( 9 )$$

Consequently, as shown by equation 10 Lₘₒₙ is the monetary cost of latency,

$${L}_{mon} ( \overline{w} ) = {w}_{j} ( {TX}_{inc} ) {T}_{dly} ∀ i ∈ ℕ \qquad ( 10 )$$

$${TX}_{inc} = \frac{{T}_{dly}}{{TX}_{intvl}} \qquad ( 11 )$$

$${ϕ}_{2} = \frac{1}{{TX}_{intvl}} \qquad ( 12 )$$

$${TX}_{i n c} = {ϕ}_{2} {T}_{dly} \qquad ( 13 )$$

$${L}_{m o n} ( \overline{w} ) = {ϕ}_{2} ( {w}_{j} {T}_{dly} ) \qquad ( 14 )$$

whereas, TX_{inc} are the intended but incomplete transactions per unit time due to the latency in key-generation process.
(3) the Security cost represents the monetary risk involved with the security of the system. The security cost need be minimized in order to protect end-user's assets. The security cost is further expanded into two elements: the unlinkability cost and the unforgeability cost.
(3.a) the unlinkability cost determines whether selected architecture offers the unlinkability for w or not. The existence of unlinkability parameter for wⱼ is represented by SL such that, SL∈{0,1}: (SL=0) if unlinkability is offered and (SL=1) if it is not. Therefore, selector should choose the key generation architecture that ensures the unlinkability feature to minimize the security cost that is incurred in the absence of unlinkability, as given by equation 15.

$$S 1 ( u , {w}_{s e l e c t} ) = {min}_{∀ j ∈ J} SL ( u , {w}_{j} ) \qquad ( 15 )$$

$$S {1}_{m o n} ( \overline{w} ) = {w}_{j} {A}_{loss} SL \qquad ( 16 )$$

$$SL = {ϕ}_{3} \qquad ( 17 )$$

$$S {1}_{m o n} ( \overline{w} ) = {ϕ}_{3} ( {w}_{j} {A}_{l o s s} ) \qquad ( 18 )$$

equation 16 represents the monetary cost associated with the unlinkability in the key-generation architecture, where as, Aₗₒₛₛ is the monetary funds at risk due to the lack of unlinkability.
(3.b) the unforgeability cost determines whether selected architecture offers the unforgeability for w̅ or not. The existence of unforgeability parameter for wⱼ is represented by SF such that, SF∈{0,1}: (SF=0) if unforgeability is offered and (SF=1) if it is not. Therefore, selector should choose the key generation architecture that ensures the unforgeability feature to minimize the security cost that is incurred in the absence of unforgeability, as given by equation 19.

$$S 2 ( u , {w}_{s e l e c t} ) = {min}_{∀ j ∈ J} SF ( u , {w}_{j} ) \qquad ( 19 )$$

$$S {2}_{m o n} ( \overline{w} ) = {w}_{j} {A}_{loss} SF \qquad ( 20 )$$

$$SF = {ϕ}_{4} \qquad ( 21 )$$

$$S {2}_{m o n} ( \overline{w} ) = {ϕ}_{4} ( {w}_{j} {A}_{l o s s} ) \qquad ( 22 )$$

Equation 19 represents the monetary cost associated with the unforgeability in the key-generation architecture, where as, Aₗₒₛₛ is the monetary funds at risk due to the lack of unforgeability.

Optimization Problem: The objective functions that need to be minimized can be represented as equation 23.

$${𝒞}_{t o t a l} ( \overline{w} ) = {M}_{m o n} + {L}_{m o n} + S {1}_{m o n} + S {2}_{m o n} \qquad ( 23 )$$

Where, substituting (7), (14), (18), and (22) in 23 results in equation 24.

$${𝒞}_{t o t a l} ( \overline{w} ) = {ϕ}_{1} ( {w}_{j} {m}_{addr} {H}_{c} ) + {ϕ}_{2} ( {w}_{j} {T}_{dly} ) + {ϕ}_{3} ( {w}_{j} {A}_{loss} ) + {ϕ}_{4} ( {w}_{j} {A}_{loss} ) \qquad ( 24 )$$

Thus the optimization problem may be formulated as follows,

$${min}_{∀ j ∈ J} {𝒞}_{t o t a l} ( \overline{w} ) \qquad ( 25 )$$

subject to \ddot{w}∈,

$${w}_{j} {ℳ}_{u t i l} {H}_{c} \leq α \qquad ( 26 )$$

$${w}_{j} ( T {X}_{i} ) {T}_{d} \leq β \qquad ( 27 )$$

$${w}_{j} {A}_{loss} SL \leq ϵ \qquad ( 28 )$$

$${w}_{j} {A}_{loss} SF \leq ϵ \qquad ( 29 )$$

where a in (26) represents the memory designated for the wallet implementation, while β in (27) represents the transaction intervals. Lastly, e in (28) and (29) represents maximum acceptable monetary loss if the security is compromised.

The cost optimization problem in equation 23 depends on numerous static and variable parameters, making it a computationally complex problem. Therefore, we first propose a matching theory-based method that optimally assigns key-generation architectures to wallet user's sessions while keeping the overall system cost low.

### Proposed Selector Mechanisms

### Many-to-One Matching Theory Based Optimization Solution

Recently, matching-theory has evolved to solve the problem of matching between two disjointed sets of players where players in one set define their preference order against the players in the other set.

In our case, U and J are the two sets for user sessions and available key generation architectures establishing a relation based on their preference lists that results in their mutual and overall advantage of the system.

We recall below the basic definition of a matching game and relate it to the key generation architecture assignment.

Definition: Consider two sets of players, U and J. Essentially, a matching game is a pair (U, J) where U and J have preference relations >u and >j, allowing each player in U to be assigned to the player in J while expressing their preference for the player in J.

In other words, a matching function μ(.) is executed that defines the relation between u and j such that u∈U and j∈J on the basis of their preference relations (>u, >j), the preferences are evaluated on the basis of self-defined utility function. Let [symbol] _{u,j}(.) be the utility function of the system for user's session u and key-generation architecture j, respectively. We can say that, if [symbol] _{u,j}(j₁)> [symbol] _{u,j}(j₂), the user's session u will prefers key-generation architecture j₁ over j₂ and such situation is expressed as j₁>uj₂.

### Preference List

The utility function of a matching pair (u, J) is evaluated by considering the several cost factors mentioned in section 3, as a result we have:

$${𝒫}_{u} ( \overline{w} ) = \frac{1}{( {w}_{j} {ℳ}_{u t i l} {H}_{c} + + {w}_{j} ( T {X}_{i} ) {T}_{d} + {w}_{j} {A}_{loss} S L + {w}_{j} {A}_{loss} S F )} \qquad ( 30 )$$

substituting Equations (3), (10), (16), and (20) in Equation (31) will result in,

$${𝒫}_{u . j} ( \overline{w} ) = \frac{1}{{ϕ}_{1} ( {w}_{j} {m}_{addr} {H}_{c} ) + {ϕ}_{2} ( {w}_{j} {T}_{dly} + {ϕ}_{3} ( {w}_{j} {A}_{loss} ) + {ϕ}_{4} ( {w}_{j} {A}_{loss} )} \qquad ( 31 )$$

which can also be summarized as

$${P}_{u . j} ( \overline{w} ) = \frac{1}{{𝒞}_{t o t a l} ( \overline{w} )} \qquad ( 32 )$$

Thus utility of a matching pair (u, j) depends on the cost involved between both pairs. So session u will set highest preference with that architecture j with which it may have that minimum cost.

This is summarized in Algorithm 1 below:

Algorithm 1 Optimization Solution

| | |
|---|---|
| 1: | Initialize w̅, (u, P_{u,w}_{ⱼ} (w̅)) |
| 2: | w̅ ← 0 |
| 3: | (u, P_{u,w}_{ⱼ} (w̅)) ← 0 |
| 4: | for u ← u₀ to uₙ do |
| 5: | for j ← j₀ to jₙ do |
| 6: | Input {φ₁, φ₂, φ₃, φ₁} and calculate all costs for j |
| 7: | Evaluate P_{u,w}_{ⱼ}(w̅) for j |
| 8: | Store P_{u,w}_{ⱼ}(w̅) in T(u, P_{u,w}_{ⱼ}(w̅)) |
| | Find max_{∀w∈W}T(u, P_{u,w}_{ⱼ}(w̅)) s.t. Eqn (22a) − (22c) |
| 9: | Update [symbol] j |
| 10: | Assign wⱼ key-generation architecture to uᵢ session as per |
| | line 9. |
| 11: | uᵢ ← {Addr : Priv_key} |
| 12: | PM(addr : priv_key) |
| 13: | SignTx(Message, priv_key)^{u}^{ᵢ} |
| 14: | SendTx(SignTx)^{u}^{ᵢ} |
| 15: | End |

More generally, algorithm 1 takes the wallet through the following steps.
Initially collect all cost parameter values as inputs. [symbol]
Then evaluates [symbol] _{u,w}_{ⱼ}(w̅) for all possible (u,wⱼ) pairs and adds them to a 2-D table T(u, [symbol] _{u,w}_{ⱼ}(w̅)).
Once utility functions for all possible (u,j) are constructed, for each u, the j with the highest utility function is selected as preference, i.e., >j.
If ND key generation scheme is selected, request message from user-end to the ND key generation module is sent, which also asks QRNG for a random number.
QRNG generates a random number between 1 to 2²⁵⁶−1 and pass it on to the ND key generation module.
the ND key generation module, first converts it into 64 hexadecimal characters to become the private key.
After that, elliptic curve cryptography is used, generator functions and curve points are used to produce 64 character long public key.
Left most 24 characters are dropped and remaining 40 characters are served as blockchain address.
checksum is added later to make them blockchain address.
In case of an HD wallet, the QRNG number is converted to a private key of 64 hexadecimal characters, which is broken down into two parts: 32 characters for master private key and 32 characters for chaincode. master private key is also converted into a master public key.
Master private key and chain code are coupled to produce extended private key, which combines with index number to generate multiple child public and private key pairs, where, public keys are converted into addresses.
Both, address and private keys are stored in password manager as key value pairs.
The address is passed on to the end-user through wallet's user-interface, so user can use that address to receive money.
In the event, when a user wants to sign a transaction, they perform address lookup by providing address to the password manager. The password manager retrieves the private-key and wallet software selects that address and it's private key as the primary address.
As a result user can sign a transaction by filling out fund transfer information and send it using “send transaction” module, that communicates with the blockchain network only for the time transaction sending is required.

### Recurrent Neural Networks Based Cost Prediction

Initially, it is assumed that the blockchain user possesses a technical understanding of their blockchain activity and is able to input cost parameters. This enables the selector to calculate the cost of available key generation architectures and selects the one with the lowest cost. However, this may not always be the case. Many blockchain users may lack the technical knowledge and expertise to input the necessary cost parameters for their activity.

To mitigate this challenge, we propose a novel approach utilizing a Recurrent Neural Network (RNN) based cost approximation model. This model utilizes previous cost data to predict the cost of parameters ahead of time. This prediction is then used to select the optimal key generation architecture.

In this study, we employ a time-series analysis approach to predict the cost parameters and approximate the appropriate key generation architecture for a blockchain user. Specifically, we consider the user's activity samples and cost parameters as time-series data, and utilize a Long Short-Term Memory (LSTM)-based Recurrent Neural Network (RNN) to model the complex temporal dependencies in the data. This approach allows us to accurately predict the cost parameters and identify the optimal wallet architecture for upcoming user's activity.

We chose to use the LSTM-based Recurrent Neural Network (RNN) method due to its capability to retain long-term memory.

The user behavior trends and patterns associated with a wallet involve long-term dependencies in the form of time-series data. LSTM architecture, due to its ability to mitigate the vanishing gradient problem, is an appropriate approach for modeling these dependencies in the user data of a wallet.

Initially, the existing data samples are input into the LSTM model to predict the value of a sample at a future time step. Let the time-series data be represented by x={x₁, x₂, x₃ . . . , xₙ}.

In the LSTM architecture, there is an input gate that determines which new information should be retained in the current cell state. The input gate in the LSTM architecture can be mathematically represented as iₙ=φ(bᵢ+u^{T}xₙ+w^{T}hₙ₋₁), where x, is the input sequence of wallet's user data, and hₙ₋₁ is the previous time step's output vector.

The weights wᵢ, uᵢ, w_{f}, and u_{f} are the recurrent and input weights, respectively, for the LSTM model.

Furthermore, the forget gate fₙ in the LSTM architecture determines which information should be retained or discarded. The forget gate can be mathematically represented as

$${f}_{n} = φ ( {b}_{f} + {u}_{f}^{T} {x}_{n} + {w}_{f}^{T} {h}_{n - 1} )$$

where fₙ∈[0,1], a value of 1 for the forget gate allows the Long Short-Term Memory (LSTM) to retain the previous state, while a value of 0 results in the state being discarded.

The LSTM model updates its memory, denoted by Cₙ, by combining new memory content C̅ₙ with a forget factor fₙ: Cₙ=fₙCₙ−1+iₙCₙ. The new memory content, C̅ₙ, is calculated as the activation function tanh applied to a combination of the input xₙ, previous hidden state hₙ₋₁, and bias term bc.

Output of LSTM is denoted as

$${o}_{n} = φ ( {b}_{o} , {w}_{o}^{T} {x}_{n} + {u}_{o}^{T} h n - 1 ) .$$

It should be noted that oₙ serves as the output gate and hₙ represents the predicted cost parameters for the user. Our problem can be described as follows:

In an example, supervised learning techniques can be used, including manually labelling the data offline, where [symbol] ={x₁, x₂, x₃}, where x₁ is the time series data for total number of addresses used in a session, x₂ is the time series data of transactions interval of a user in each session, and x₃ is the time series data that represents if the sessions were marked with high security or low. Whereas, y={φ₁, φ₂, φ₃, φ₄} are the predicted values of X in future.

Algorithm 2 summarizes the LSTM-based user's cost prediction model.

Algorithm 2 LSTM based wallet architecture selection

| | |
|---|---|
| 1: | Initialize Model |
| 2: | Initialize X |
| 3: | Train LSTM |
| 4: | Predict hₙ for x₁, x₂, x₃ in the future |
| 5: | {φ₁, φ₂, φ₃} = {h₁, h₂, h₃} |
| 6: | for j ← j₀ to jₙ do |
| 7: | Input {φ₁, φ₂, φ₃, φ₁} and calculate all costs for j |
| 8: | Evaluate P_{u,w}_{ⱼ}(w̅) for j |
| 9: | Store P_{u,w}_{ⱼ}(w̅) in T(u, P_{u,w}_{ⱼ}(w̅)) |
| | Find max_{∀w∈W}T(u, P_{u,w}_{ⱼ}(w̅)) s.t. Eqn (22a) − (22c) |
| 10: | Update [symbol] j |
| 11: | Assign wⱼ key-generation architecture to uᵢ session as per |
| | line 9. |
| 12: | uᵢ ← {Addr : Priv_key} |
| 13: | PM(addr : priv_key) |
| 14: | SignTx(Message, priv_key)^{u}^{ᵢ} |
| 15: | SendTx(SignTx)^{u}^{ᵢ} |

### Implementation Evaluation

### System Setup

We simulated raspberry pie (OS raspios-bullseye-i386) with 2048 MB RAM and 1.9 GHz processor to evaluate our wallet solution and generated results. We used Pandas, and Sklearn libraries for machine learning, ReactJS framework for front-end and ExpressJS library for the backend implementation.

### Results

Due to the personal nature of wallets, a public dataset is currently unavailable. As a result, we opted to generate a synthetic dataset by randomly simulating users' wallet usage. Our approach involved incorporating three parameters—address count, transaction interval, and security—and generating user activity over a six-day period. Each hour of activity was considered a summarized session, and we utilized LSTM model to predict future session values for the three parameters. Our comparative analysis involved evaluating our proposed wallet architecture, referred to as Qwallet, against two existing architectures—HD and ND. The results of our study demonstrate that Qwallet strikes a balance among memory utilization, security, and risk of monetary loss, and outperforms the available architectures.

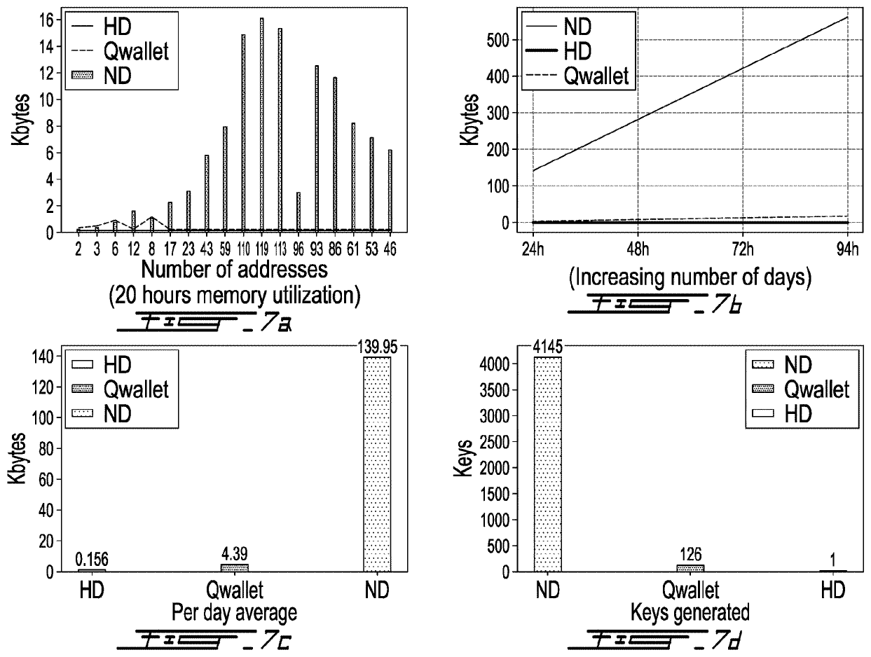

FIG. 7 illustrates that over a period of twenty hours, as the number of addresses used varies, the HD wallet consistently maintains low memory utilization. This is because the HD wallet only needs to store the root seed. In contrast, the ND wallet's memory utilization for each session is directly proportional to the number of addresses generated by the user in that session.

In contrast, Qwallet utilizes a smart approach to determine whether to generate an address from the HD or ND wallet based on various factors outlined above. As a result, during sessions where Qwallet employs independent keys for added security, there is a noticeable increase in memory utilization. However, in sessions where independent keys are not needed, the memory utilization is similar to that of the HD wallet.

Similarly, FIGS. 7A-7D demonstrate that the ND wallet has a linear impact on memory consumption as the number of days increases. This indicates that the ND wallet will eventually consume all available memory for storing keys. In contrast, the HD wallet's memory consumption remains exceptionally low. However, Qwallet offers a solution that combines the security benefits of ND with memory utilization close to that of the HD wallet, specifically during required sessions.

FIGS. 7A-7D display the average memory consumption of Qwallet in comparison to existing architectures. The results demonstrate that the HD wallet has a small average memory consumption of 0.15 kilobytes, while the ND wallet has an extremely high average memory consumption of 140 kilobytes. However, Qwallet has an average memory consumption that is closer to the HD wallet, measuring at approximately 4.38 kilobytes.

The daily average memory consumption is directly proportional to the number of keys generated by each wallet type during an equal number of sessions. FIGS. 7A-7D highlights that the ND wallet generated 4156 keys, the HD wallet generated only one key, and Qwallet generated 126 keys while inheriting the same security characteristics as an existing ND wallet.

Therefore, Qwallet offers high security features similar to the ND wallet, without incurring additional memory overhead.

In the following step, we will assess the effectiveness of our prediction algorithm, which utilizes the Long Short-Term Memory (LSTM) deep neural network technique to forecast various user parameters. These parameters include the transaction interval, number of addresses used, and security prioritization. Once predicted, these parameters are then utilized by the wallet architecture selection module to identify the optimal wallet architecture that reduces the overall system cost during a specific session, as also explained in Section 3.

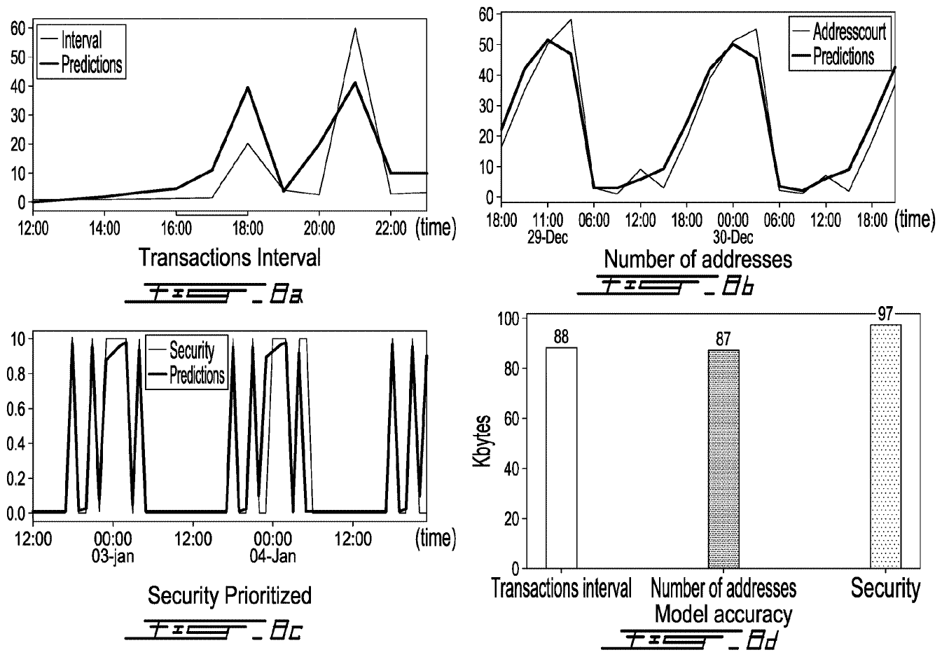

FIGS. 8A-8D portray the prediction of transaction intervals, i.e., the time duration between two consecutive transactions executed by a user. Our observation indicates that our prediction model is capable of forecasting future transaction intervals with minimal deviation. Moreover, the predicted transaction interval values exhibit a similar trend to the actual transaction values from the dataset, and are in close proximity to them. This trend persists throughout the observation period of the subsequent 12 hours.

FIGS. 8A-8D depicts the prediction of the number of addresses generated by a user. Our findings demonstrate that our prediction algorithm is able to forecast the number of addresses that a user will generate with minimal error. The predicted values follow a similar trend to the actual values from the dataset, and there is little deviation between the two. This pattern remains consistent throughout the subsequent 12-hour observation period.

In FIGS. 8A-8D, we present the results of our prediction algorithm for a user's security prioritization. Our evaluation demonstrates that our model can effectively forecast this parameter with a high degree of accuracy and little deviation. The predicted values align closely with the actual values derived from the dataset, indicating the robustness of our approach. This trend remains consistent throughout the 24-hour observation period, highlighting the reliability of our prediction model.

We evaluated the accuracy of our prediction model by calculating the R2_scores for the continuous value time series of transaction interval and number of addresses. This metric provided a measure of the accuracy of our model for these parameters. For security prioritization, which is a binary value time series, we calculated the binary_accuracy. This approach allowed us to determine the effectiveness of our model for predicting binary time series values.

As illustrated in FIGS. 8A-8D, our prediction model exhibits a high degree of accuracy in forecasting future parameter values. Specifically, we achieved an 88% accuracy rate in predicting transaction intervals and an 87% accuracy rate in forecasting the number of addresses for future sessions. Our security prioritization model performed even better, achieving a 97% accuracy rate. These results indicate that our model's predictions are highly reliable and acceptable.

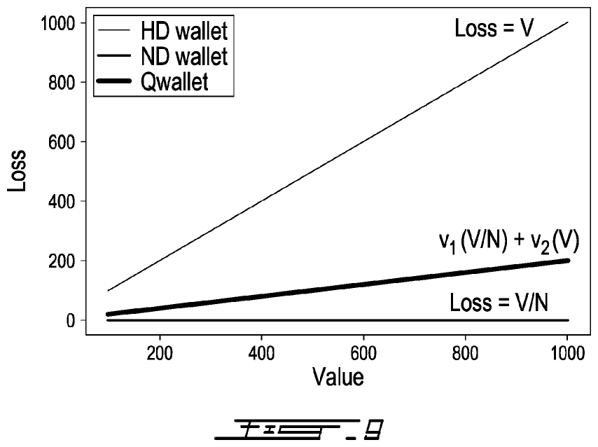

In FIG. 9, we assess the potential loss of funds in the event of key compromise or leakage. Our visualization demonstrates that in the context of HD wallets, the security of all assets depends exclusively on the protection of a single root seed. Any compromise of this root seed would result in a complete loss of funds, leading to the formulation Loss=V, where V represents the total value of assets held within the wallet.

As part of our assessment, we developed a model to characterize the loss function associated with ND wallets. Given the proportional relationship between the number of keys generated and the number of addresses, the total value of assets is distributed across multiple keys. As a result, the average loss incurred can be described as Loss=V/N, where N represents the number of keys utilized. Our analysis demonstrates that the degree of loss incurred is minimal.

Furthermore, we evaluated the loss function for Qwallet and found it can be modeled as Loss=V₁(V/N)+V₂(N), where V₁ represents the portion of assets stored and backed by keys when Qwallet chose the ND architecture, and V₂ represents the portion of assets stored and backed by keys when Qwallet selected the HD architecture. We conducted a systematic evaluation of the loss for increasing asset values and found that while the loss incurred in HD wallets increases linearly, the loss in ND wallets is minimal. Our evaluation indicates that Qwallet incurs sub-minimal losses and is closer in performance to ND wallets.

Accordingly, a new wallet design, which can be referred to as Qwallet in this example, can be provided that employs a weighted approach to balance memory usage, security, and the risk of monetary loss. Through a comparative analysis with two existing architectures, HD and ND, Qwallet can surpass them in terms of average memory consumption, number of generated keys, and security features. Furthermore, we have utilized the Long Short-Term Memory (LSTM) deep neural network technique to predict various user parameters, such as the number of addresses, transaction interval, and security prioritization. Our findings indicate that our prediction model accurately forecasts future transaction intervals, security prioritization, and the number of addresses generated by the user with minimal variance. Moving forward, we aim to extend our research to support diverse blockchain systems.

It will be understood that the expression “computer” as used herein is not to be interpreted in a limiting manner. It is rather used in a broad sense to generally refer to the combination of some form of one or more processing units and some form of memory system accessible by the processing unit(s). The memory system can be of the non-transitory type. The use of the expression “computer” in its singular form as used herein includes within its scope the combination of a two or more computers working collaboratively to perform a given function. Moreover, the expression “computer” as used herein includes within its scope the use of partial capabilities of a given processing unit. Example computers include desktop, laptop, smartphone, smart watch, less elaborated controller devices, etc.

A processing unit can be embodied in the form of a general-purpose micro-processor or microcontroller, a digital signal processing (DSP) processor, an integrated circuit, a field programmable gate array (FPGA), a reconfigurable processor, a programmable read-only memory (PROM), to name a few examples.

The memory system can include a suitable combination of any suitable type of computer-readable memory located either internally, externally, and accessible by the processor in a wired or wireless manner, either directly or over a network such as the Internet. A computer-readable memory can be embodied in the form of random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) to name a few examples.

A computer can have one or more input/output (I/O) interface to allow communication with a human user and/or with another computer via an associated input, output, or input/output device such as a keyboard, a mouse, a touchscreen, an antenna, a port, etc. Each I/O interface can enable the computer to communicate and/or exchange data with other components, to access and connect to network resources, to serve applications, and/or perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, Bluetooth, WiMAX), SS7 signaling network, fixed line, local area network, wide area network, to name a few examples.

It will be understood that a computer can perform functions or processes via hardware or a combination of both hardware and software. For example, hardware can include logic gates included as part of a silicon chip of a processor. Software (e.g. application, process) can be in the form of data such as computer-readable instructions stored in a non-transitory computer-readable memory accessible by one or more processing units. With respect to a computer or a processing unit, the expression “configured to” relates to the presence of hardware or a combination of hardware and software which is operable to perform the associated functions. Different elements of a computer, such as processor and/or memory, can be local, or in part or in whole remote and/or distributed and/or virtual.

The methods and systems of the present disclosure may be implemented in a high level procedural or object oriented programming or scripting language, or a combination thereof, to communicate with or assist in the operation of a computer system, for example the controller 31. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 402 of the computing device 400, to operate in a specific and predefined manner to perform the functions described herein, for example those described in the method presented in FIG. 3 or 4.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments. The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

As can be understood, the examples described above and illustrated are intended to be exemplary only. The scope is indicated by the appended claims.

What is claimed is:

1. A computer-implemented method of operating a blockchain wallet, the method comprising:
receiving a key generation request from a user;
providing at least one value of a cost parameter associated to the user;
calculating a cost value for a first key generation scheme using a cost function for the first key generation scheme and the at least one value of a cost parameter;
calculating a cost value for a second key generation scheme using a cost function for the second key generation scheme and the at least one value of a cost parameter;
comparing the cost value for the first key generation scheme to the cost value for the second key generation scheme;
selecting one of the first key generation scheme and the second key generation scheme based on the results of the comparison;
generating a blockchain key based on the selected key generation scheme; and
storing the blockchain key in a computer memory.

2. The computer-implemented method of claim 1, further comprising: receiving a key retrieval request from a user, and retrieving the blockchain key from the non-transitory computer memory in response to the key retrieval request.

3. The computer-implemented method of claim 1 wherein the first key generation scheme involves generating a root seed from a random number, generating a master address from the root seed, and generating child addresses from the master address or from child addresses in a tree-like structure.

4. The computer-implemented method of claim 1 wherein the second key generation scheme involves generating a private key from a random number, and generating a public key from the private key using elliptic curve cryptography.

5. The computer-implemented method of claim 1 wherein the first key generation scheme is a hierarchical-deterministic key generation scheme, whereas the second key generation scheme is a non-deterministic key generation scheme.

6. The computer-implemented method of claim 1 wherein the at least one cost parameter includes at least one of an indication of number of addresses, an indication of transaction interval, and an indication of required security level.

7. The computer-implemented method of claim 1 wherein the at least one cost parameter includes at least three cost parameters including an indication of number of addresses, an indication of transaction interval, and an indication of required security level.

8. The computer-implemented method of claim 1 further comprising receiving the at least one value of a cost parameter as a user input.

9. The computer-implemented method of claim 1 further comprising determining the at least one value of a cost parameter from data including values of the at least one cost parameters from a history of past key generation requests from the user.

10. The computer-implemented method of claim 9 wherein said determining includes using a trained machine-learning engine.

11. The computer-implemented method of claim 1 wherein the non-transitory memory forms part of an electronic device which is connectable to a computer.

12. The computer-implemented method of claim 1 wherein the non-transitory memory forms part of a cloud service.
